(19) United States
(12) Patent Application Publication
(10) Pub. No.: US 2026/0153122 A1
(43) Pub. Date: Jun. 4, 2026

(54) RADIALLY CONTROLLED BEARING ASSEMBLY FOR RACK SYSTEM OF A VEHICLE STEERING SYSTEM

(71) Applicant: Steering Solutions IP Holding Corporation, Saginaw, MI (US)

(72) Inventors: Brad S. Sundholm, Bay City, MI (US); Robert C. Derocher, Essexville, MI (US); Thomas J. Carter, Goodrich, MI (US); Joseph Nigl, Chesaning, MI (US); Matthew T. Strickler, Saginaw, MI (US)

(21) Appl. No.: 19/404,901

(22) Filed: Dec. 1, 2025

Related U.S. Application Data
(60) Provisional application No. 63/726,739, filed on Dec. 2, 2024.

(51) Int. Cl. F16C 19/18; B62D 5/04; F16C 33/30

(52) U.S. Cl. CPC F16C 19/184; B62D 5/0442; F16C 33/30; F16C 2326/24

(57) ABSTRACT

A vehicle steering system includes a rack housing. The vehicle steering system also includes a linear translating component disposed within the rack housing. The vehicle steering system further includes a bearing assembly. The bearing assembly includes an inner race. The bearing assembly also includes an outer race having a radially outer surface disposed adjacent to an inner wall of the rack housing, the radially outer surface extending from a first axial end to a second axial end, the radially outer surface having a flange extending radially outwardly. The bearing assembly yet further includes a sleeve disposed radially between the radially outer surface of the outer race and the inner wall of the rack housing.

### CROSS-REFERENCE TO RELATED APPLICATION

This application claims the benefits of priority to U.S. Provisional Patent Application No. 63/726,739 , filed Dec. 2, 2024, the disclosure of which is incorporated by reference herein in its entirety.

### FIELD OF THE INVENTION

This application relates to vehicle steering systems and, more particularly, to a radially controlled bearing assembly for a rack system of a vehicle steering system.

### BACKGROUND OF THE DISCLOSURE

Vehicle steering systems typically include a rack extending between tie rods to control a position of vehicle road wheels to carry out steering maneuvers. The rack is located within a rack housing. One or more bearing assemblies may be required at one or more locations along the rack to maintain a desired position and performance of the rack.

Various electric power steering (EPS) systems have been developed for assisting an operator with vehicle steering. One type of EPS system is referred to as a rack electric power steering (REPS) system that utilizes an electric motor which drives a ball nut and rack. The rack teeth are engaged with a pinion which complements a driving feature that is rotated in response to rotation of a portion of the steering column by an operator, with the driving feature providing a steering input to the rack. The driving feature may be integrated with the steering column (i.e., single pinion electric power steering system) or may be a driving pinion (i.e., dual pinion electric power steering system), for example.

The above-noted bearing assembly may be in direct contact with the rack or with a ball nut which electromechanically actuates movement of the rack. For example, some ball nut bearing assemblies include an isolation mechanism used in REPS systems. Some bearing assemblies use low clearance slip fits between the bearing outer race flange and the housing bore to constrain elastomer isolators within their gland—thereby preventing elastomer extrusion—but also allowing the bearing to move axially within the housing when high axial rack load events occur. This axial movement is controlled by compression and decompression of the elastomer isolators within their respective glands. The bearing outer race flange can contact the housing bore when load is applied in the radial direction because the isolators do not completely limit bearing travel in the radial direction. This metal-to-metal contact causes NVH issues, particularly when REPS systems are heated/cooled which results in a change in the size of the slip fit between the bearing outer race flange and the housing bore due to the difference in the coefficients of thermal expansion of the components. Such ball nut bearing isolation designs may not meet some OEMs' requirements for NVH performance with a temperature profile overlay.

### SUMMARY

According to one aspect of the disclosure, a vehicle steering system includes a rack housing. The vehicle steering system also includes a linear translating component disposed within the rack housing. The vehicle steering system further includes a bearing assembly. The bearing assembly includes an inner race. The bearing assembly also includes an outer race having a radially outer surface disposed adjacent to an inner wall of the rack housing, the radially outer surface extending from a first axial end to a second axial end, the radially outer surface having a flange extending radially outwardly. The bearing assembly yet further includes a sleeve disposed radially between the radially outer surface of the outer race and the inner wall of the rack housing.

According to another aspect of the disclosure, a bearing assembly disposed within a housing of a vehicle steering system. The bearing assembly includes an inner race. The bearing assembly also includes an outer race having a radially outer surface disposed adjacent to an inner wall of the rack housing, the radially outer surface extending from a first axial end to a second axial end, the radially outer surface having a flange extending radially outwardly. The bearing assembly further includes a first isolator adjacent to a first axial edge of the flange. The bearing assembly yet further includes a second isolator adjacent a second axial edge of the flange, wherein the first isolator and the second isolator are formed of a deformable material. The bearing assembly also includes a sleeve disposed radially between the flange of the outer race and the inner wall of the rack housing.

These and other advantages and features will become more apparent from the following description taken in conjunction with the drawings.

### BRIEF DESCRIPTION OF THE DRAWINGS

The subject matter of the present disclosure is particularly pointed out and distinctly claimed in the claims at the conclusion of the specification. The foregoing and other features, and advantages of the present disclosure are apparent from the following detailed description taken in conjunction with the accompanying drawings in which:

FIG. 1 schematically illustrates a vehicle steering system.

FIG. 2 is an elevational view of a rack assembly of the vehicle steering system.

FIG. 3 is a cross-sectional view of a bearing assembly for the rack assembly according to one aspect of the disclosure.

FIG. 4 is a cross-sectional view of the bearing assembly for the rack assembly according to another aspect of the disclosure.

### DETAILED DESCRIPTION

Referring now to the Figures, where the present disclosure will be described with reference to specific embodiments, without limiting same, it is to be understood that the disclosed embodiments are merely illustrative of the present disclosure that may be embodied in various and alternative forms. The Figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

The embodiments described herein are used in conjunction with a steering assembly of a vehicle, such as a car, truck, sport utility vehicle, crossover, mini-van, marine craft, aircraft, all-terrain vehicle, recreational vehicle, or other suitable vehicles which include various steering system schemes. The radially controlled bearing assembly disclosed herein may be beneficial for several types of vehicle steering systems. For example, the radially controlled bearing assembly may be utilized in any type of steering system to control the position and movement of a rack itself. Additionally, the bearing assembly may be provided in any type of electric power steering (EPS) system, such as systems having rack electric power steering (REPS), column electric power steering (CEPS), and pinion electric power steering (PEPS). Additionally, the bearing assembly may be provided in steer-by-wire systems having no continuous physical connection between the steering handwheel and the rack, including systems with no pinion connected to the rack to counteract forces induced by actuation with an electric power system.

At a fundamental level, the rack is any linear translating component, which may also be referred as a rack or a ball screw, for example. In some embodiments, the bearing assembly is a ball nut itself and is rotated to actuate translation of the linear translating component. In such an embodiment, the inner race of the bearing assembly is in contact with threads of the ball screw. In other embodiments, the inner race is in contact with the outer diameter of a separate ball nut that carries out translation of the ball screw.

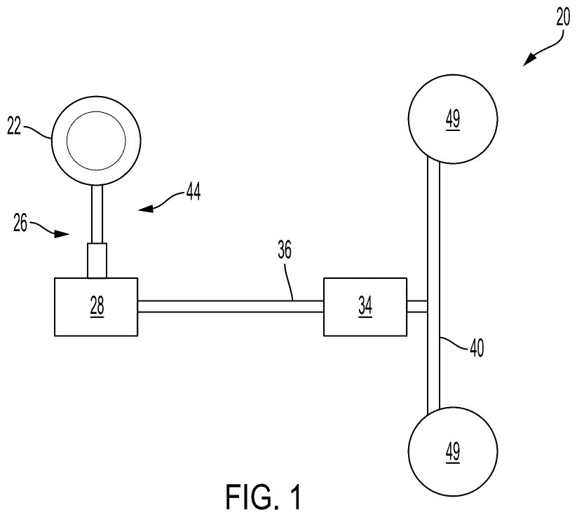

Referring initially to FIG. 1, a power steering system 20 is generally illustrated. The power steering system 20 may be configured as a driver interface steering system, an autonomous driving system, or a system that allows for both driver interface and autonomous steering. The steering system may include an input device 22, such as a steering wheel, wherein a driver may mechanically provide a steering input by turning the steering wheel. A steering column 26 extends along an axis from the input device 22 to an output assembly 28. The embodiments disclosed herein are utilized in steering systems where the output assembly 28 is in operative communication (e.g., steer-by-wire, autonomous system, etc.) with an actuator 34 that is coupled to a linear translating component 40. The output assembly 28 has wired electrical communication 36 with the actuator 34. Actuator 34 drives the linear translating component 40 to provide steering control of the vehicle.

The linear translating component 40 is any component having a generally cylindrical cross-section along at least a portion of the length thereof and is driven in a substantially linear manner to effectuate adjustment of vehicle road wheels 49. In some embodiments, the linear translating component 40 is a ball screw. In other embodiments, the linear translating component 40 is a lead screw. The preceding examples are not limiting of the linear translating component 40.

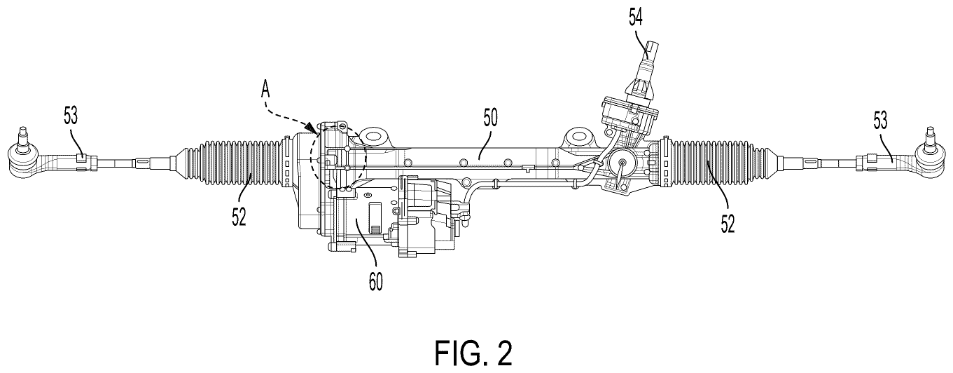

Referring to FIG. 2, a rack housing 50 is shown with a pair of sealing components 52, such sealing boots, operatively coupled to ends of the rack housing 50. The rack housing 50 houses the linear translating component 40. A pair of tie rods 53 are shown at ends of the linear translating component 40 and extending from the sealing components 52. A pinion 54 is positioned to extend through an opening of the rack housing 50 to be in contact (not shown) with the linear translating component 40 to provide steering inputs from a vehicle operator.

The illustrated embodiment is a rack electric power steering (REPS) system having an electric motor 60 which actuates movement of the linear translating component 40 to assist the vehicle operator with steering maneuvers. However, as described above the bearing assembly disclosed herein may be used in several different types of steering systems. As also described above, the location of the bearing assembly may vary depending on the particular type of steering system it is utilized within. An example of one location is referenced with character A in FIG. 2.

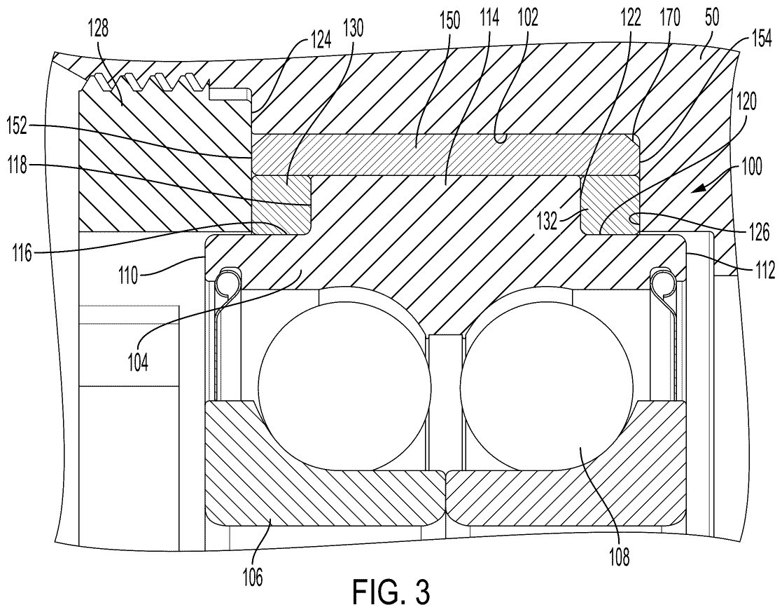

FIG. 3 is a cross-sectional view of the bearing assembly 100 disclosed herein. The bearing assembly 100 is located at an inner wall 102 of the rack housing 50. The bearing assembly 100 is located within the interior space defined by the rack housing 50 and between the rack housing 50 and the linear translating component 40 (e.g., rack, ball screw, lead screw, etc.). As described above, in some embodiments the bearing assembly 100 is a ball nut itself and is rotated to actuate translation of the linear translating component, while in other embodiments the inner race is in contact with the outer diameter of a separate ball nut that carries out translation of the ball screw. In yet other embodiments, the bearing assembly is in direct contact with the linear translating component 40.

The bearing assembly 100 includes an outer race 104 and an inner race 106. The outer race 104 and the inner race 106 define a space for balls 108 of the bearing assembly 100 to move within. In the illustrated embodiment, a dual row bearing is shown to accommodate two rows of balls 108. However, it is to be appreciated that more or fewer rows may be present in other embodiments.

The outer race 104 extends from a first axial end 110 (at left in orientation of FIG. 3) to a second axial end 112 (at right in orientation of FIG. 3). A flange 114 extends radially outward along the outer race 104 in contact with an intermediate component located between the outer race 104 and the rack housing 50. The flange 114 provides a pair of land areas along the radially outer surface of the outer race 104. In particular, a first land area 116 extends from the first axial end 110 of the outer race 104 to a first axial edge 118 of the flange 114 and a second land area 120 extends from the second axial end 112 of the outer race 104 to an opposite, second axial edge 122 of the flange 114.

As shown, the outer race 104 of the bearing assembly 100 is positioned at an axial location of the rack housing inner wall 102. The flange 114 of the outer race 104 is located between a first shoulder 124 and a second shoulder 126 of the inner wall 102 of the rack housing 50. The first shoulder 124 (at left in orientation of FIG. 3) is positioned to accommodate a threaded retainer 128 which fixes the axial position of the bearing assembly 100. The first shoulder 124 may also provide a hard stop for the threaded retainer 128. The second shoulder 126 of the rack housing inner wall 102 (at right in orientation of FIG. 3) is located on the other side of the flange 114 of the outer race 104.

The first axial edge 118 of the flange 114 of the outer race 104 and the threaded retainer 128 defines a first axial space. The second axial edge 122 of the flange 114 of the outer race 104 and the second shoulder 126 defines a second axial space. A first isolator 130 is positioned within the first axial space and a second isolator 132 is positioned with the second axial space. Each isolator 130, 132 is formed of a deformable material, such as an elastomer in some embodiments. The isolators 130, 132 fill a portion of the overall axial space, but this overall space is difficult to fill in a desired manner due to design tolerances and manufacturing processes. The bearing assembly 100 disclosed herein provides a premium steering feel and thermal performance. Even tightening tolerances on some or all specification dimensions related to isolation gland fill percentage will leave some axial space, thereby resulting in undesirable rattle of the components (i.e., NVH issues).

A sleeve 150 is positioned between the outer diameter of the flange 114 of the outer race 104 and the rack housing inner wall 102. Additionally, in the illustrated embodiment of FIG. 3, the sleeve 150 is positioned radially between the inner wall 102 of the rack housing 50 and the first and second isolators 130, 132. In particular, the sleeve 150 extends axially from a first axial sleeve end 152 to a second axial sleeve end 154, with the sleeve 150 axially overlapping an entirety of the outer race flange outer diameter, as well as at least a portion of the first and second isolators 130, 132. The first axial sleeve end 152 and the threaded retainer 128 define a small clearance therebetween in the illustrated embodiment, while the second end of the sleeve is in contact with the second shoulder of the rack housing. It is contemplated that the first axial sleeve end 152 is in direct contact with the threaded retainer 128 in other embodiments. A chamfer 170 may be present along the radially outer portion of the second axial sleeve end 154 in any of the embodiments disclosed herein.

The outer diameter of the sleeve 150 is press fit to the inner wall 102 of the rack housing 50 in the embodiment of FIG. 3. Therefore, the sleeve is positionally fixed relative to the rack housing 50. The inner diameter of the sleeve 150 and the outer diameter of the flange 114 of the outer race 104 are positioned in a low clearance slip fit assembled condition to allow the outer race 104 to move relative to the sleeve 150. The bearing outer race 104 to the sleeve inside diameter may be slip fit or interference fit.

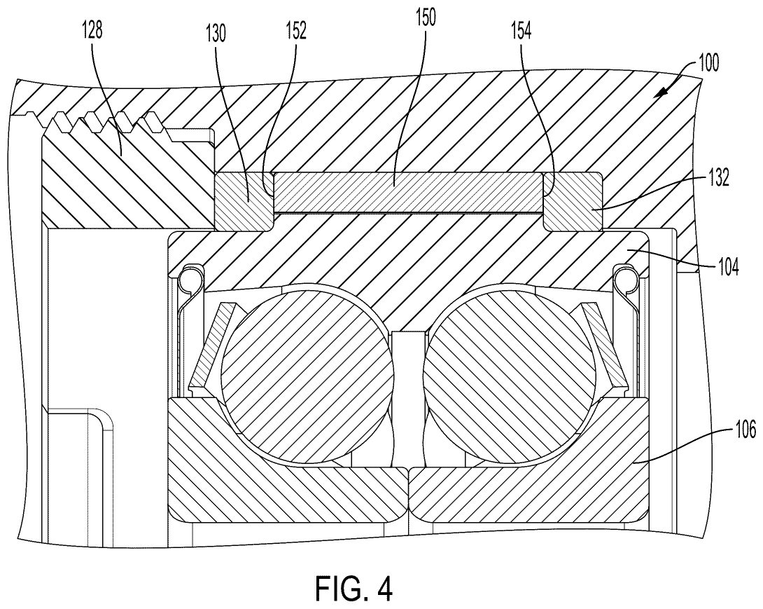

Another aspect of the disclosure is shown in FIG. 4. The sleeve 150 is radially disposed between the outer diameter of the flange 114 and the inner diameter of the rack housing 50, as with the embodiment of FIG. 3, but the axial footprint of the sleeve 150 within the gland is less than that of the embodiment of FIG. 3. In particular, the sleeve 150 is not disposed radially between the first and second isolators 130, 132 and the rack housing inner diameter. The first axial end 152 of the sleeve 150 abuts an axial surface of the first isolator 130 and the second axial end 154 of the sleeve 150 abuts an axial surface of the second isolator 132. In other words, first isolator 130 is axially located between the threaded retainer 128 and the sleeve 150 and the second isolator 132 is axially located between the sleeve 150 and the second shoulder 126 of the inner wall 102 of the rack housing 50.

In some embodiments, the sleeve 150 disclosed herein is formed of plastic, but it is to be appreciated that other suitable materials with a high coefficient of thermal expansion may be utilized.

In the embodiments disclosed herein, the sleeve 150 is installed into the rack housing isolation bearing bore to act as a radial damper to the interface between the housing bore surface (i.e., inner wall 102) and the bearing outer race flange 114. The sleeve 150 also acts as a thermal expansion/contraction compensator to the interface between the bearing outer race 104 and the installed sleeve inside diameter. The sleeve 150 also acts as a constraining gland wall for the isolators 130, 132. The sleeve 150 also acts as a thermal expansion/contraction compensator to minimize the elastomer isolator extrusion gap size at a range of temperatures for isolator durability.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate with the scope of the present disclosure. Additionally, while various embodiments of the present disclosure have been described, it is to be understood that aspects of the present disclosure may include only some of the described embodiments or combinations of the various embodiments. Accordingly, the present disclosure is not to be seen as limited by the foregoing description.

What is claimed is:

1. A vehicle steering system comprising:
a rack housing;
a linear translating component disposed within the rack housing; and
a bearing assembly comprising:
an inner race;
an outer race having a radially outer surface disposed adjacent to an inner wall of the rack housing, the radially outer surface extending from a first axial end to a second axial end, the radially outer surface having a flange extending radially outwardly; and
a sleeve disposed radially between the radially outer surface of the outer race and the inner wall of the rack housing.

2. The vehicle steering system of claim 1, further comprising:
a first isolator adjacent to a first axial edge of the flange; and
a second isolator adjacent to a second axial edge of the flange.

3. The vehicle steering system of claim 2, wherein the first isolator and the second isolator are formed of a deformable material.

4. The vehicle steering system of claim 3, wherein the first isolator and the second isolator are formed of an elastomer.

5. The vehicle steering system of claim 1, wherein the sleeve is formed of plastic.

6. The vehicle steering system of claim 2, wherein the sleeve is located radially between the first isolator and the inner wall of the rack housing, radially between the flange and the inner wall of the rack housing, and radially between the second isolator and the inner wall of the rack housing.

7. The vehicle steering system of claim 6, wherein the sleeve is press fit to the inner wall of the rack housing.

8. The vehicle steering system of claim 2, wherein the sleeve is located axially between the first isolator and the second isolator, wherein the sleeve is located radially between the flange and the inner surface of the rack housing.

9. The vehicle steering system of claim 8, wherein the sleeve is press fit to the radially outer surface of the flange of the outer race.

10. A bearing assembly disposed within a housing of a vehicle steering system, the bearing assembly comprising:
an inner race;
an outer race having a radially outer surface disposed adjacent to an inner wall of the rack housing, the radially outer surface extending from a first axial end to a second axial end, the radially outer surface having a flange extending radially outwardly;
a first isolator adjacent to a first axial edge of the flange;
a second isolator adjacent a second axial edge of the flange, wherein the first isolator and the second isolator are formed of a deformable material; and
a sleeve disposed radially between the flange of the outer race and the inner wall of the rack housing.

11. The bearing assembly of claim 10, wherein the first isolator and the second isolator are formed of an elastomer.

12. The bearing assembly of claim 11, wherein the sleeve is formed of plastic.

13. The vehicle steering system of claim 10, wherein the sleeve is located radially between the first isolator and the inner wall of the rack housing, radially between the flange and the inner wall of the rack housing, and radially between the second isolator and the inner wall of the rack housing.

14. The vehicle steering system of claim 13, wherein the sleeve is press fit to the inner wall of the rack housing.

15. The vehicle steering system of claim 10, wherein the sleeve is located axially between the first isolator and the second isolator, wherein the sleeve is located radially between the flange and the inner surface of the rack housing.

16. The vehicle steering system of claim 15, wherein the sleeve is press fit to the radially outer surface of the flange of the outer race.
